(19) United States
(12) Patent Application Publication
(10) Pub. No.: US 2015/0212930 A1
(43) Pub. Date: Jul. 30, 2015

(54) APPLICATION TEST SYSTEM, APPLICATION TEST METHOD AND STORAGE MEDIUM

(71) Applicant: SJI Inc., Tokyo (JP)

(72) Inventor: Li Shuiping, Tokyo (JP)

(21) Appl. No.: 14/512,517

(22) Filed: Oct. 13, 2014

(30) Foreign Application Priority Data
Jan. 29, 2014 (JP) 2014-014811

(51) Int. Cl. G06F 11/36; H04N 7/18

(52) U.S. Cl. CPC G06F 11/3676; H04N 7/183

(57) ABSTRACT

An application test system includes a management server for managing an operation status of an operating terminal that is operated to test an application and an operation status of an operated terminal that is remotely operated in accordance with the operation of the operating terminal, wherein the management server includes operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and operation information transmission means for transmitting the operation information to the operated terminal in which the application under test and an operation program for operating the operated terminal based on the operation information are installed.

### CROSS-REFERENCE TO RELATED APPLICATION

This application is based upon and claim the benefit of priority from the prior Japanese Patent Application No. 2014-014811, filed on Jan. 29, 2014, the entire contents of which are incorporated herein by reference.

### TECHNICAL FIELD

The present invention relates to an application test system, an application test method and a storage medium.

### BACKGROUND ART

These days, operating systems (OSs) of terminals such as smartphones, tablets, and PCs (hereinafter referred to as “terminal(s)”) are updated frequently, and there are various versions of OSs and a great number of models that are compatible with these OSs. Accordingly, a developer of an application (hereinafter referred to as a “test person”) has to test an application for each of various OSs and compatible models, which makes testing operation complicate.

As a solution for such a problem, an application test system for testing an application on a browser is known (see Non Patent Literature 1).

In the application test system described in Non Patent Literature 1, application test is performed by virtualizing on a server in advance a plurality of terminals in which various versions of OSs are installed, and operating the virtualized terminals on a browser.

### CITATION LIST

Non Patent Literature

Non Patent Literature 1: “Automated platform for smartphone application/site testing”, [online], retrieved on Jan. 14, 2014, Internet, <URL: http://www.scirocco-cloud.com/>

### SUMMARY OF INVENTION

### Technical Problem

However, in the application test system described in Non Patent Literature 1, a terminal under test is just a virtualized terminal, and is not an actual terminal (a real machine). Thus, with the application test system described in Non Patent Literature 1, the behavior of an application at a real machine cannot be checked, and accurate application test cannot be performed. This is because operations on a virtual terminal are not necessarily the same as those on a real machine due to the difference of operating environment therebetween.

Moreover, in the application test system described in Non Patent Literature 1, a test is performed for each model and thus, a plurality of terminals in which various versions of OSs are installed cannot be simultaneously checked, which makes the application test inefficient and increases testing workload.

Accordingly, the present invention has been made in view of the circumstances described above, and aims to provide an application test system, an application test method and a storage medium which allow for a great reduction of the testing workload by simultaneous checking of a plurality of terminals in which various versions of OSs are installed, and accurate application test through the testing operation using a real machine.

### Solution to Problem

An application test system according to a first aspect of the present invention is an application test system for testing an application at a plurality of terminals, the application test system including a management server for managing an operation status of an operating terminal that is operated to test an application and an operation status of an operated terminal that is remotely operated in accordance with operation of the operating terminal, wherein the management server includes operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and operation information transmission means for transmitting the operation information to the operated terminal in which the application under test and an operation program for operating the operated terminal based on the operation information are installed.

An application test system according to a second aspect of the present invention is an application test system for testing an application at a plurality of terminals, the application test system including a management server for managing an operation status of an operating terminal that is operated to test an application and an operation status of an operated terminal that is remotely operated in accordance with operation of the operating terminal, wherein the management server includes application reception means for receiving an application under test, processed application transmission means for transmitting a processed application obtained by injecting a terminal operation monitor program for monitoring the operation of the operating terminal into the application under test, operation information reception means for receiving, from the operating terminal in which the processed application is installed, the operation information of the operating terminal that is monitored by the terminal operation monitor program, and operation information transmission means for transmitting the operation information to the operated terminal in which the application under test and an operation program for operating the operated terminal based on the operation information are installed.

An application test system according to a third aspect of the present invention is an application test system for testing an application at a plurality of terminals, the application test system including an operated terminal to be remotely operated in accordance with operation of an operating terminal that is operated to test an application, and a management server for managing operation statuses of the operating terminal and the operated terminal, wherein the management server includes operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and operation information transmission means for transmitting the operation information to the operated terminal in which the application under test and an operation program for operating the operated terminal based on the operation information are installed, and wherein the operated terminal includes operation information reception means for receiving the operation information from the management server, and operation program control means for executing the operation program based on the operation information.

An application test system according to a fourth aspect of the present invention is an application test system for testing an application at a plurality of terminals, the application test system including an operating terminal that is to be operated to test an application, an operated terminal that is to be remotely operated in accordance with operation of the operating terminal, and a management server for managing operation statuses of the operating terminal and the operated terminal, wherein the management server includes operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and operation information transmission means for transmitting the operation information to the operated terminal in which the application under test and an operation program for operating the operated terminal based on the operation information are installed, wherein the operating terminal includes operation information generation means for generating, when being operated, the operation information based on the terminal operation monitor program, and operation information transmission means for transmitting the operation information to the management server, and wherein the operated terminal includes operation information reception means for receiving the operation information from the management server, and operation program control means for executing the operation program based on the operation information.

An application test system according to a fifth aspect of the present invention is an application test system for testing an application at a plurality of terminals, the application test system including a management server for managing an operation status of an operating terminal that is operated to test an application and an operation status of an operated terminal that is remotely operated in accordance with operation of the operating terminal, wherein the management server includes operation information reception means for receiving, from the operating terminal in which an application under test and a terminal operation monitor program for monitoring the operation of the operating terminal are installed, operation information of the operating terminal that is monitored by the terminal operation monitor program, and operation information transmission means for transmitting the operation information to the operated terminal in which the application under test and an operation program for operating the operated terminal based on the operation information are installed.

An application test system according to a sixth aspect of the present invention is the application test system according to the first aspect of the present invention, wherein the management server further includes video data reception means for receiving, from the operated terminal, video data regarding the operation status of the operated terminal, and video data transmission means for transmitting the video data to an operation display terminal for displaying the operation status of the operated terminal.

An application test system according to a seventh aspect of the present invention is the application test system according to the third aspect of the present invention, wherein the operated terminal further includes video data generation means for generating video data regarding the operation status of the operated terminal, and video data transmission means for transmitting the video data to the management server, and wherein the management server further includes video data reception means for receiving the video data from the operated terminal, and video data transmission means for transmitting the video data to an operation display terminal for displaying the operation status of the operated terminal.

An application test system according to an eighth aspect of the present invention is the application test system according to the third aspect of the present invention, further including an operation display terminal for displaying the operation status of the operated terminal, wherein the operated terminal further includes video data generation means for generating video data regarding the operation status of the operated terminal, and video data transmission means for transmitting the video data to the management server, wherein the management server further includes video data reception means for receiving the video data from the operated terminal, and video data transmission means for transmitting the video data to the operation display terminal, and wherein the operation display terminal includes video data reception means for receiving the video data from the management server, and video data display means for displaying the video data.

An application test system according to a ninth aspect of the present invention is the application test system according to the sixth aspects of the present invention, wherein the management server further includes video file generation means for generating a video file recording the video data.

An application test system according to a tenth aspect of the present invention is the application test system according to the first aspects of the present invention, wherein the management server further includes operation record file generation means for generating an operation record file recording the operation information.

An application test method according to an eleventh aspect of the present invention is an application test method for testing an application at a plurality of terminals, the method comprising the following steps performed by a management server for managing an operation status of an operating terminal that is operated to test an application and an operation status of an operated terminal that is remotely operated in accordance with operation of the operating terminal to perform receiving, from the operating terminal in which a processed application obtained by injecting a terminal operation monitor program for monitoring the operation of the operating terminal into an application under test is installed, operation information of the operating terminal that is monitored by the terminal operation monitor program, and transmitting the operation information to the operated terminal in which the application under test and an operation program for operating the operated terminal based on the operation information are installed.

An application test program storage medium according to a twelfth aspect of the present invention is a tangible non-transitory computer-readable storage medium having the application test program stored therein, wherein the application test program configures a computer to perform as the hardware processor of the first aspect of the present invention.

### Advantageous Effects of Invention

According to the first to fifth, eleventh and twelfth aspects of the present invention, the operated terminal can be remotely operated in accordance with the operation of the operating terminal, and thus, a plurality of terminals in which various versions of OSs are installed may be simultaneously checked, and the testing workload can be greatly reduced (efficient application test can be carried out). Furthermore, according to these aspects of the present invention, real machines can be used as the operating terminal and the operated terminal, and an operation status of an application unique to a real machine, which cannot be checked with a virtual terminal, can be checked (accurate application test including operation unique to a real machine can be carried out).

According to the sixth to eighth aspects of the present invention, since the management server includes means for receiving video data regarding the operation status of the operated terminal, and means for transmitting the video data to the operation display terminal for displaying the operation status of the operated terminal, the test person can check the status of application test (the operation status of the operated terminal) in real time through the operation display terminal. Thus, the test person does not have to directly check the operation statuses of a plurality of operated terminals while operating the operating terminal, and can check the operation statuses of a plurality of operated terminals simultaneously through the operation display terminal, and thus, according to these aspects of the present invention, application test can be performed efficiently.

According to the ninth aspect of the present invention, since the management server includes means for generating a video file recording video data regarding the operation status of the operated terminal, the test person can recheck the operation status of the operated terminal after completion of the application test (the operation status of the operated terminal is checked by a replay video). Therefore, according to this aspect of the present invention, the operation status of the operated terminal can be checked after a series of testing operations using a real machine.

According to the tenth aspect of the present invention, since the management server includes means for generating an operation record file recording the operation information of the operating terminal, the test person can, at the time of reperforming application test, operate the operated terminal based on the operation information recorded in the operation record file without operating the operating terminal again (testing can be automated). Therefore, according to this aspect of the present invention, the same application test can be repeatedly performed, and thus, accurate application test can be performed efficiently and reliably.

### BRIEF DESCRIPTION OF DRAWINGS

FIG. 1 is a diagram showing an overall configuration of an application test system according to Embodiment 1 of the present invention;

FIG. 2 is a diagram showing a hardware configuration of a management server of the application test system according to Embodiment 1 of the present invention;

FIG. 3 is a block diagram showing a configuration of the application test system according to Embodiment 1 of the present invention;

FIG. 4 is a flow chart showing a procedure for remotely operating an operated terminal in accordance with operation of an operating terminal in the application test system according to Embodiment 1 of the present invention;

FIG. 5 is a flow chart showing a procedure for displaying, on an operation display terminal, video data regarding an operation status of the operated terminal in the application test system according to Embodiment 1 of the present invention;

FIG. 6 is a flow chart showing a procedure for displaying, at the operation display terminal, a replay video regarding an operation status of the operated terminal in the application test system according to Embodiment 1 of the present invention;

FIG. 7 is a flow chart showing a procedure for automatically reperforming application test in the application test system according to Embodiment 1 of the present invention; and

FIG. 8 is a diagram showing a screen display where the video data regarding an operation status of the operated terminal is displayed at the operation display terminal of the application test system according to Embodiment 1 of the present invention.

### DESCRIPTION OF EMBODIMENTS

Hereinafter, an embodiment for carrying out the present invention will be described in detail with reference to the appended drawings.

### Embodiment 1

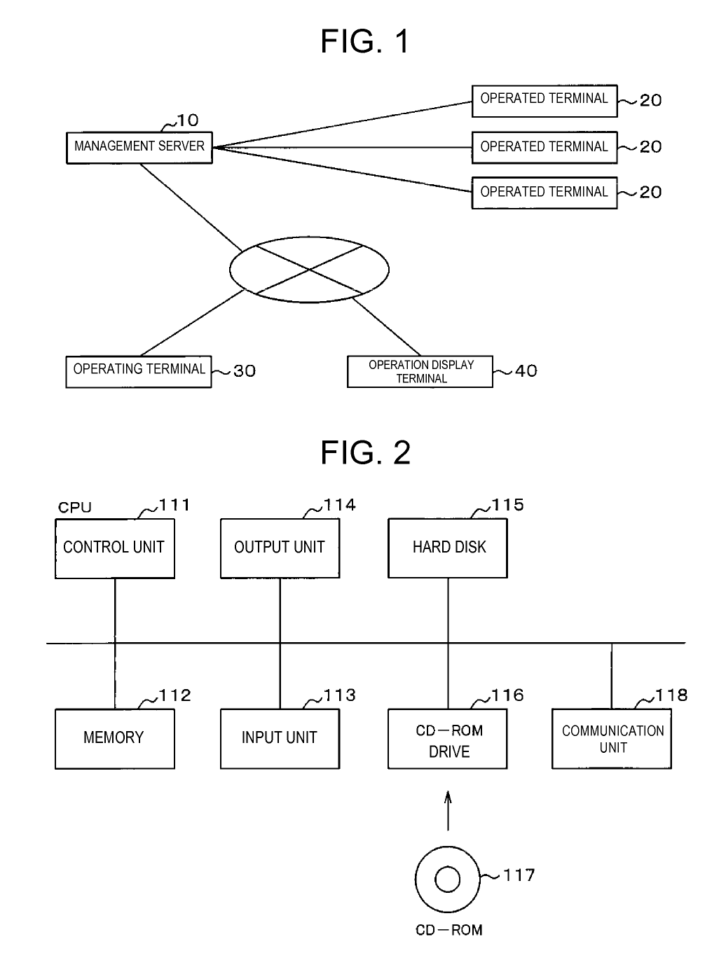

FIG. 1 is a diagram showing an overall configuration of an application test system according to Embodiment 1 of the present invention.

The present application test system is configured from a management server 10 for managing the operation status of an operating terminal 30 and the operation status of an operated terminal 20, the operating terminal 30 which is operated to test an application, the operated terminal 20 which is remotely operated in accordance with the operation of the operating terminal 30 (there is one to n operated terminal(s) 20 (n is an integer of one or more)), and an operation display terminal 40 for displaying the operation status of the operated terminal 20.

The management server 10 is connected to the operating terminal 30 and the operation display terminal 40 over the Internet, and the operated terminal 20 is connected to the management server 10 by wired connection using a cable or the like, or by wireless connection such as near field wireless connection.

Additionally, in the present application test system, in the case of providing an application test service to the operating terminal 30 and the operation display terminal 40, a user of the operating terminal 30 and the operation display terminal 40, when seen from the management server 10 and the operated terminal 20, may be referred to as a client (a test person who uses the application test service; hereinafter referred to as a “test person”), and a person who uses the management server 10 and the operated terminal 20, when seen from the test person, may be referred to as a service provider.

Next, the hardware configurations of the management server 10, the operated terminal 20, the operating terminal 30, and the operation display terminal 40 will be described. FIG. 2 is a diagram showing the hardware configuration of the management server of the application test system according to Embodiment 1 of the present invention.

The management server 10 includes a control unit 111, a memory 112, an input unit 113 such as a keyboard, an output unit 114 such as a display, a hard disk 115, a CD-ROM drive 116, and a communication unit 118. The communication unit 118 exchanges information with the operated terminal 20, the operating terminal 30, and the operation display terminal 40.

The operated terminal 20 and the operating terminal 30 are configured by hardware of a smartphone, a tablet terminal, a small personal computer (PC) or the like having a network connection function (not shown). The operation display terminal 40 is configured by a personal computer (PC) having a network connection function (not shown).

Next, the operation of the application test system configured in the above manner will be described.

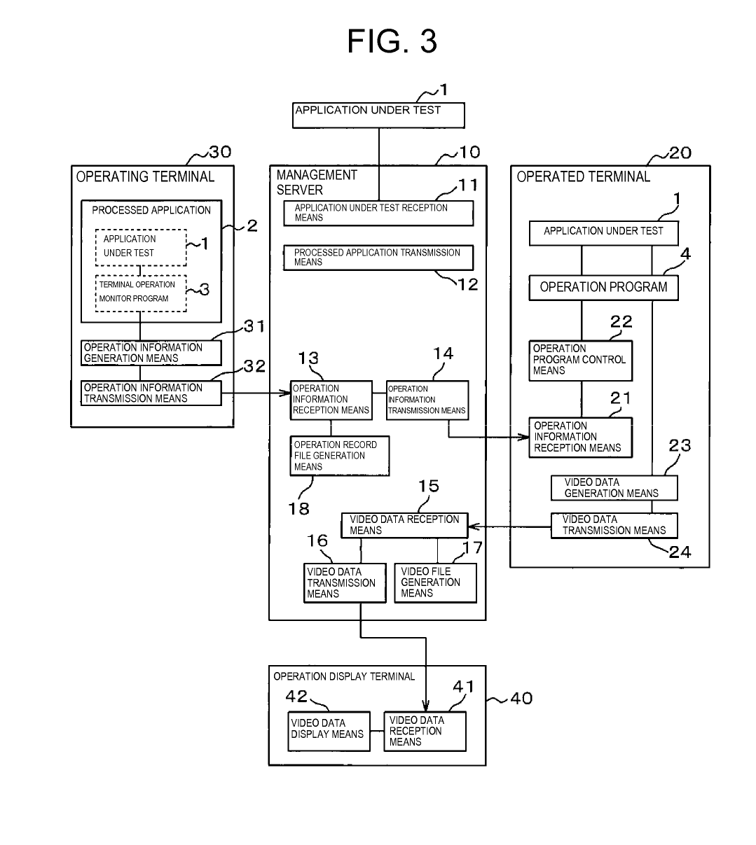

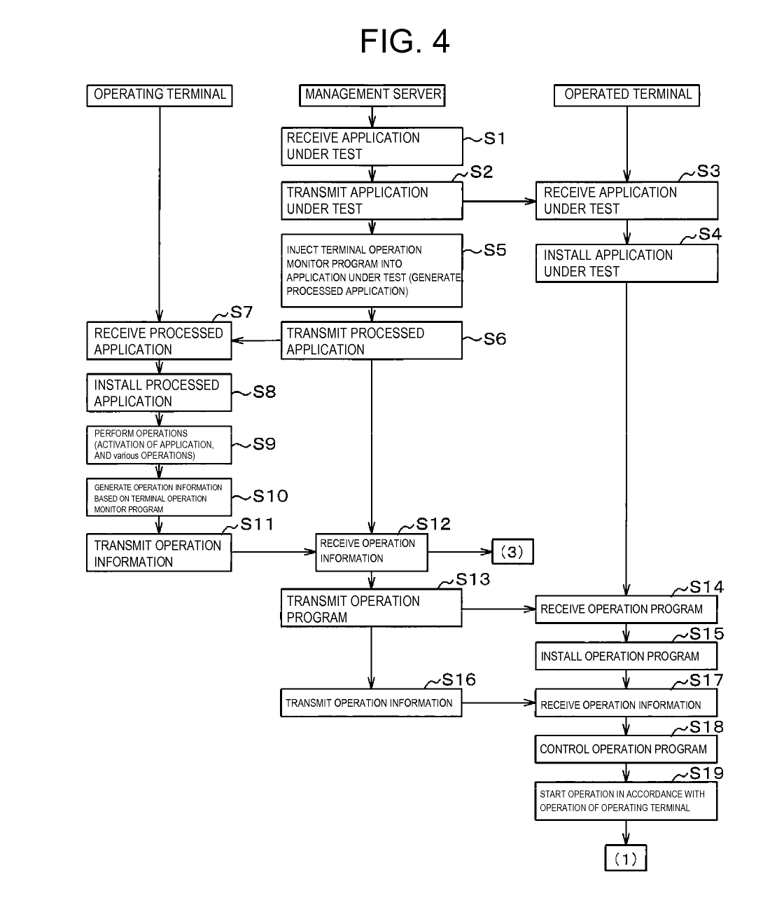

First, an operation of remotely operating the operated terminal 20 in accordance with the operation of the operating terminal 30 will be described with reference to FIGS. 3 and 4. FIG. 3 is a block diagram showing a configuration of the application test system according to Embodiment 1 of the present invention, and FIG. 4 is a flow chart showing a procedure for remotely operating the operated terminal 20 in accordance with the operation of the operating terminal 30 in the application test system according to Embodiment 1 of the present invention.

First, in step S1, the management server 10 receives an application under test 1 by the communication unit 118 over the Internet (application under test reception means 11). More specifically, the management server 10 receives the application under test 1 transmitted from a terminal on the side of the test person (for example, the operation display terminal 40), and stores the same in the hard disk 115.

In step S2, the management server 10 transmits the application under test 1 to the operated terminal 20 by the communication unit 118. In step S3, the operated terminal 20 receives the application under test 1 transmitted from the management server 10. The received application under test 1 is stored in a memory (not shown) of the operated terminal 20.

In step S4, the operated terminal 20 installs the application under test 1 that is stored in the memory. Preferably, an automatic installation program may be installed in advance in the operated terminal 20, and the application under test 1 may be automatically installed in the operated terminal 20 when the application under test 1 is stored in the memory of the operated terminal 20.

In step S5, the management server 10 injects, into the application under test 1, a terminal operation monitor program 3 for monitoring an operation of the operating terminal 30 and generating operation information indicating how the terminal was operated (an application obtained by injecting the terminal operation monitor program 3 into the application under test 1 will hereinafter be referred to as a “processed application”). More specifically, the code of the terminal operation monitor program 3 is added to the code of the application under test 1. Here, the terminal operation monitor program 3 is desirably composed of a code not dependent on the application under test 1. This is for swiftly performing the injection task by formally adding the code of the terminal operation monitor program 3 to the code of the application under test 1. Preferably, the terminal operation monitor program 3 may be stored in the hard disk 115 of the management server 10 in advance.

In step S6, the management server 10 transmits a processed application 2 to the operating terminal 30 by the communication unit 118 (processed application transmission means 12). In step S7, the operating terminal 30 receives the processed application 2 transmitted from the management server 10. The received processed application 2 is stored in a memory (not shown) of the operating terminal 30. In step S8, the test person installs the processed application 2 in the operating terminal 30.

In step S9, the test person performs the operations of the operating terminal 30 so as to test the application under test 1. The operations of the operating terminal 30 include activation of the application under test 1 and operations for various functions of the application under test 1. Additionally, the application that is installed in the operating terminal 30 is the processed application 2, and since, as described above, the processed application 2 is the application under test 1 into which the terminal operation monitor program 3 has been injected, the application under test 1 is actually operated by the test person through the operating terminal 30 (this is because the terminal operation monitor program 3 aims to simply monitor the operation of the operating terminal 30, and does not change the program content of the application under test 1).

In step S10, the operating terminal 30 generates operation information according to operation of the operating terminal 30 by the test person (operation information generation means 31). More specifically, when the test person operates the application under test 1 through the operating terminal 30, the content of the operation is stored in the memory of the operating terminal 30 as the operation information, based on the terminal operation monitor program 3 injected in the application under test 1. For example, in the case where the operating terminal 30 is a smartphone, when the test person taps an icon of the application under test 1 on a display screen (not shown) (activation of the application under test 1), information that the icon has been tapped is stored in the memory of the operating terminal 30 as the operation information, based on the terminal operation monitor program 3. When the test person performs a touch panel operation such as tapping or flicking, an attitude control operation of the operating terminal 30 or the like so as to fulfill various functions of the application under test 1 (for example, in the case of a schedule management application, an input/update function for schedule or task), information about the operation is also stored in the memory of the operating terminal 30 as the operation information, based on the terminal operation monitor program 3.

In step S11, the operating terminal 30 transmits the operation information stored in the memory to the management server 10 (operation information transmission means 32). In step S12, the management server 10 receives the operation information from the operating terminal 30 by the communication unit 118 (operation information reception means 13). The management server 10 stores the received operation information in the memory 112.

In step S13, the management server 10 transmits an operation program 4 to the operated terminal 20 by the communication unit 118. The operation program here refers to a program for operating the operated terminal 20 based on the operation information generated by the operating terminal 30. Preferably, the operation program 4 may be stored in the hard disk 115 of the management server 10 in advance.

In step S14, the operated terminal 20 receives the operation program 4 from the management server 10. The received operation program 4 is stored in the memory of the operated terminal 20. In step S15, the operated terminal 20 installs the operation program 4 stored in the memory. Preferably, an automatic installation program may be installed in advance in the operated terminal 20, and the operation program 4 may be automatically installed in the operated terminal 20 when the operation program 4 is stored in the memory of the operated terminal 20.

In step S16, the management server 10 transmits the operation information to the operated terminal 20 by the communication unit 118 (operation information transmission means 14). In step S17, the operated terminal 20 receives the operation information from the management server 10 (operation information reception means 21). The received operation information is stored in the memory of the operated terminal 20.

In step S18, the operated terminal 20 starts control of the operation program 4 so as to execute the operation program 4 based on the operation information stored in the memory (operation program control means 22). More specifically, when the operation program 4 is executed, a control unit (not shown) of the operated terminal 20 controls the entire operated terminal 20 to perform an operation of the content same as that of the operation information (the operation content of the operating terminal 30). For example, if the operating terminal 30 is a smartphone, when the test person taps an icon of the application under test 1 on a display screen (not shown) of the operating terminal 30 (that is the activation of the application under test 1), information that the icon has been tapped (operation information) is transmitted from the operating terminal 30 to the operated terminal 20 via the management server 10 (steps S11, S16, and S17). Then, when the operated terminal 20 which has received the operation information executes the operation program 4 based on the operation information, the control unit of the operated terminal 20 starts control of the entire operated terminal 20 so as to perform an operation of the same content as the content of the operation information (the content is that an icon of the application under test 1 has been tapped at the operating terminal 30), and the same operation as that performed at the operating terminal 30 is performed at the operated terminal 20 (the operated terminal 20 is remotely operated in accordance with the operation of the operating terminal 30; step S19). Additionally, the same procedure is performed also when the test person performs an operation such as tapping or flicking so as to realize various functions of the application under test 1 (for example, in the case of a schedule management application, an input/update function for schedule or task) on the operating terminal 30.

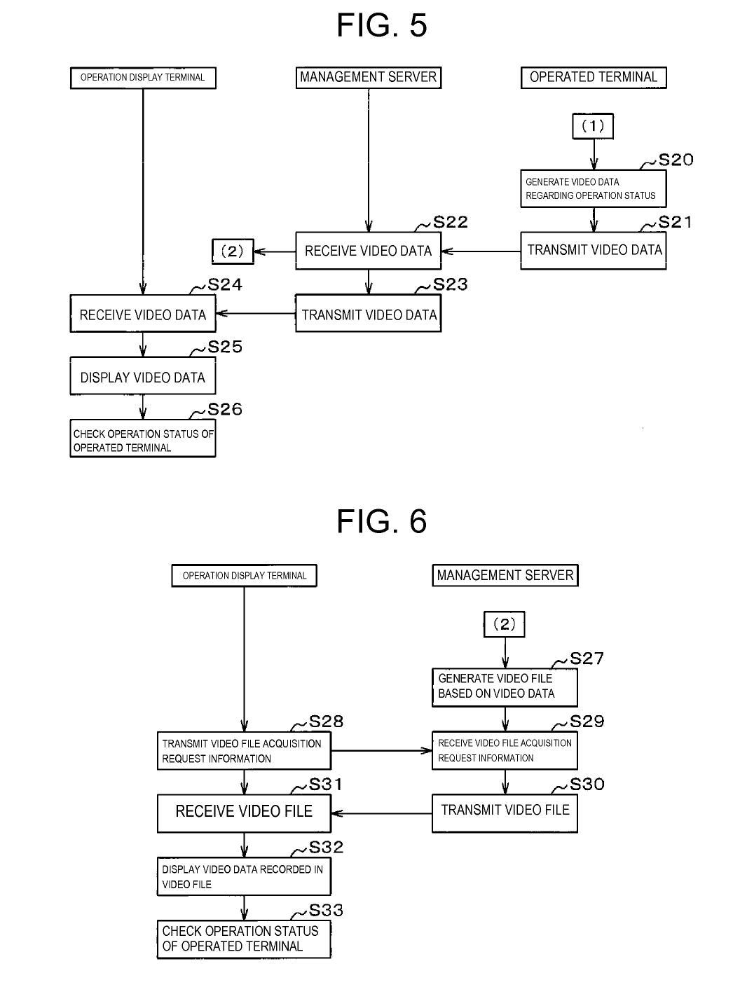

Next, an operation of displaying video data regarding an operation status of the operated terminal 20 at the operation display terminal 40 will be described with reference to FIGS. 3, 5 and 8. FIG. 5 is a flow chart showing a procedure for displaying, on the operation display terminal, video data regarding an operation status of the operated terminal in the application test system according to Embodiment 1 of the present invention. Moreover, FIG. 8 is a diagram showing a screen display where the video data regarding an operation status of the operated terminal is displayed at the operation display terminal of the application test system according to Embodiment 1 of the present invention.

In step S20, the operated terminal 20 generates video data regarding an operation status of the operated terminal 20 (a status of being remotely operated in accordance with the operation of the operating terminal 30) (video data generation means 23). More specifically, first, a video data generation program for generating video data regarding an operation status of the operated terminal 20 is installed in advance in the operated terminal 20. Then, the operated terminal 20 sequentially stores as the video data, in the memory, based on the video data generation program, the status of being remotely operated in accordance with the operation of the operating terminal 30 (that is the content of the operation status of the operated terminal 20 displayed on a screen (not shown) which is a display unit of the operated terminal 20).

In step S21, the operated terminal 20 transmits the video data which was stored in the memory in step S20 to the management server 10 (video data transmission means 24). In step S22, the management server 10 receives, by the communication unit 118, the video data transmitted from the operated terminal 20 (video data reception means 15). Additionally, the received video data is stored in the memory 112 of the management server 10. In step S23, the management server 10 transmits the video data to the operation display terminal 40 by the communication unit 118 (video data transmission means 16).

In step S24, the operation display terminal 40 receives the video data transmitted from the management server 10 (video data reception means 41). The video data is stored in a memory (not shown) of the operation display terminal 40. In step S25, the operation display terminal 40 displays the video data stored in the memory on a display unit (a display; not shown) of the operation display terminal 40 (see FIG. 8; video data display means 42). In step S26, the test person checks the operation status of the operated terminal 20 (the status of the operated terminal 20 being remotely operated in accordance with the operation of the operating terminal 30) through the display unit (the display) of the operation display terminal 40.

Additionally, when applying a live streaming method (a method of encoding video data in real time and distributing the data by streaming) to the flow from step S20 to S25 described above (from generation of video data to display of video data), the test person can check the operation status of the operated terminal 20 in real time.

Next, an operation for displaying, at the operation display terminal 40, a replay video regarding an operation status of the operated terminal 20 will be described with reference to FIGS. 3 and 6. FIG. 6 is a flow chart showing a procedure for displaying, at the operation display terminal, a replay video regarding an operation status of the operated terminal in the application test system according to Embodiment 1 of the present invention.

In step S27, the management server 10 generates a video file based on the video data stored in the memory 112 in step S22 (video file generation means 17). The video file here is video data regarding a series of operation statuses for all the processes of the application test of the operated terminal 20 where the video data is recorded in a file format. The video file is stored in the hard disk 115 of the management server 10.

In step S28, the test person requests the service provider for acquisition of the video file which was generated by the management server 10 in step S27. For example, the test person transmits video file acquisition request information to the management server 10 from the operation display terminal 40.

In step S29, when the management server 10 has received the video file acquisition request information from the test person through the communication unit 118, the management server 10 transmits the video file to the operation display terminal 40 by the communication unit 118 (step S30).

In step S31, the operation display terminal 40 receives the video file transmitted from the management server 10. The video file is stored in the memory of the operation display terminal 40.

In step S32, the operation display terminal 40 displays the video file stored in the memory on the display unit (the display) of the operation display terminal 40 (screen display same as that in FIG. 8 is obtained). In step S33, the test person checks again, through the display unit (the display) of the operation display terminal 40, the series of operation statuses for all the processes of the application test of the operated terminal 20 (checking of a replay video regarding the operation status of the operated terminal 20).

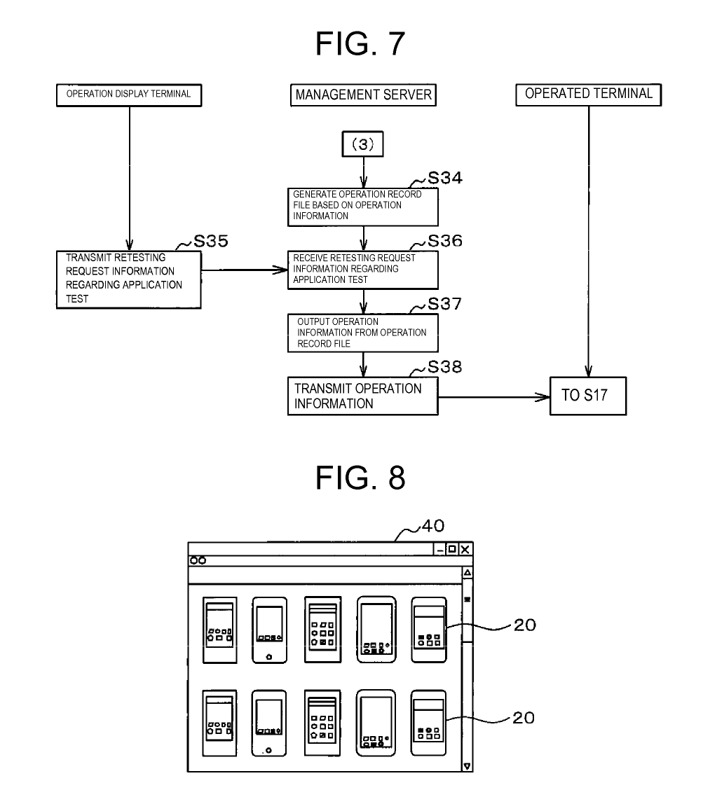

Lastly, an operation for automatically reperforming testing of the application under test 1 will be described with reference to FIGS. 3 and 7. FIG. 7 is a flow chart showing a procedure for automatically reperforming application test in the application test system according to Embodiment 1 of the present invention.

In step S34, the management server 10 generates an operation record file based on the operation information which was stored in the memory 112 in step S12 (operation record file generation means 18). The operation record file here is content of a series of operations of all the processes of the application test of the operating terminal 30 where the content is recorded in a file format. The operation record file is stored in the hard disk 115 of the management server 10.

In step S35, the test person requests the service provider for re-performance of application test. For example, the test person transmits retesting request information regarding application test to the management server 10 from the operation display terminal 40.

In step S36, when the management server 10 has received the retesting request information regarding application test from the test person through the communication unit 118, the management server 10 outputs the operation information from the operation record file which is stored in the hard disk 115 (step S37).

In step S38, the management server 10 transmits the operation information output from the operation record file to the operated terminal 20 by the communication unit 118 (operation information transmission means 14). Thereafter, the operated terminal 20 is operated based on the operation information by repeating the same procedure as the procedure from step S17. The operated terminal 20 is thereby operated based on the operation information recorded in the operation record file, and thus, testing of the application under test 1 may be reperformed automatically.

As described above, according to the present invention, by adopting the configuration described above, the operated terminal 20 can be remotely operated in accordance with the operation of the operating terminal 30, and thus, a plurality of terminals in which various versions of OSs are installed can be simultaneously checked, and the testing workload can be greatly reduced (efficient application test can be carried out). Real machines can be used as the operating terminal 30 and the operated terminal 20 according to the present invention, and an operation status of an application unique to a real machine, which cannot be checked with a virtual terminal, can be checked (accurate application test including operation unique to a real machine can be carried out).

Since the management server 10 according to the present invention includes means for receiving video data regarding the operation status of the operated terminal 20 (video data reception means 15), and means for transmitting the video data to the operation display terminal 40 (video data transmission means 16), the test person can check the status of application test (the operation status of the operated terminal 20) in real time through the operation display terminal 40. Thus, the test person does not have to directly check the operation statuses of a plurality of operated terminals 20 while operating the operating terminal 30, and can check the operation statuses of a plurality of operated terminals 20 simultaneously through the operation display terminal 40 (efficient application test is enabled).

Furthermore, according to the present invention, since the management server 10 includes means for generating a video file recording video data regarding the operation status of the operated terminal 20 (video file generation means 17), the test person can recheck the operation status of the operated terminal 20 through the operation display terminal 40 after completion of the application test (the operation status of the operated terminal 20 is checked by a replay video). Therefore, according to the present invention, accurate application test can be reliably performed.

Moreover, according to the present invention, since the management server 10 includes means for generating an operation record file recording the operation information of the operating terminal 30 (operation record file generation means 18), the test person can, at the time of reperforming application test, operate the operated terminal 20 based on the operation information recorded in the operation record file without operating the operating terminal 30 again (testing can be automated). Therefore, according to the present invention, the same application test can be repeatedly performed, and thus, accurate application test can be performed efficiently and reliably.

Additionally, in the present embodiment, the user of the operating terminal 30 and the operation display terminal 40, when seen from the management server 10 and the operated terminal 20, is the client (the test person), and the person using the management server 10 and the operated terminal 20, when seen from the test person, is the service provider, but it is also possible to provide all of the management server 10, the operated terminal 20, the operating terminal 30, and the operation display terminal 40 on the side of the test person or the service provider. Preferably, the operated terminal 20, the operating terminal 30, and the operation display terminal 40 may each be connected to the management server 10 by wired connection using a cable or the like, or by wireless connection such as near field wireless connection. It is also possible to provide only the management server 10 on the side of the service provider, and to provide the operated terminal 20, the operating terminal 30, and the operation display terminal 40 on the side of the test person. Preferably, the operated terminal 20, the operating terminal 30, and the operation display terminal 40 may each be connected to the management server 10 over the Internet.

Besides, the management server 10 in the present embodiment is to receive the application under test 1 from a terminal present on the side of the test person (for example, the operation display terminal 40), but instead, the application under test 1 that is stored in a CD-ROM 117 may be installed in the management server 10 from the CD-ROM drive 116, for example.

Furthermore, the operated terminal 20 in the present embodiment is to receive the application under test 1 and the operation program 4 from the management server 10, but instead, the application under test 1 and the operation program 4 may be input to the operated terminal 20 by a recording medium (a CD-ROM, an USB memory or the like) storing the application under test 1 and the operation program 4, for example. In addition, the application under test 1 and the operation program 4 in the present embodiment are automatically installed in the operated terminal 20, but this installation task may be performed by the service provider (or by the test person in the case where the operated terminal 20 is provided on the side of the test person).

Moreover, the management server 10 in the present embodiment is to inject the terminal operation monitor program 3 into the application under test 1 (to add the code of the terminal operation monitor program 3 to the code of the application under test 1), but this injection may be performed on the side of the test person instead. For example, since the application under test 1 is developed on the side of the test person, it is stored in a terminal on the side of the test person (for example, the operation display terminal 40), and the management server 10 transmits only the terminal operation monitor program 3 to the operation display terminal 40 provided on the side of the test person (the terminal operation monitor program 3 may be input to the operation display terminal 40 by a recording medium (a CD-ROM or the like) storing the terminal operation monitor program 3). Then, the test person injects the terminal operation monitor program 3 into the application under test 1 at the operation display terminal 40 and generates the processed application 2, and inputs the processed application 2 into the operating terminal 30. Preferably, the operating terminal 30 may be connected to the operation display terminal 40 by wired connection using a cable or the like, or by wireless connection such as near field wireless connection.

In the present embodiment, the management server 10 is to transmit the processed application 2 to the operating terminal 30 by the communication unit 118, but the processed application 2 may be transmitted to the operation display terminal 40 instead. In this case, the processed application 2 is input to the operating terminal 30 via the operation display terminal 40. Preferably, the operating terminal 30 may be connected to the operation display terminal 40 by wired connection using a cable or the like, or by wireless connection such as near field wireless connection.

Furthermore, the management server 10 in the present embodiment is to transmit the processed application 2 to the operating terminal 30 by the communication unit 118, but instead, the processed application 2 may be input to the operating terminal 30 by a recording medium (a CD-ROM, an USB memory or the like) storing the processed application 2, for example.

In the present embodiment, the management server 10 is to generate the processed application 2 by injecting the terminal operation monitor program 3 into the application under test 1, but instead of such a configuration, the application under test 1 and the terminal operation monitor program 3 may be caused to function separately on the operating terminal 30 (the processed application 2 is not generated), for example. In this case, the application under test 1 and the terminal operation monitor program 3 are separately input to the operating terminal 30 (for example, the operating terminal 30 receives the application under test 1 and the terminal operation monitor program 3 separately from the management server 10, or inputs the application under test 1 and the terminal operation monitor program 3 to the operating terminal 30 by a recording medium (a CD-ROM, an USB memory or the like) storing the application under test 1 and the terminal operation monitor program 3).

Lastly, instead of the application test system of the present embodiment, the present invention may be applied to an application test method and a program for causing a computer to function as the application test system or to perform the method. The program may be stored in a computer-readable recording medium. Additionally, the recording medium mentioned above may be the ROM itself of the application test system of the present embodiment, or a CD-ROM, a magnetic tape, a cassette tape, a flexible disk, a hard disk, an MO/MD/DVD or the like that may be read by being inserted into an external storage device (a CD-ROM drive or the like), or a semiconductor memory.

In this manner, it is needless to say that various changes may be made to the present embodiment without departing from the spirit of the present invention.

The disclosure of the Japanese patent application 2014-014811, filed on Jan. 29, 2014 including its specification, claims and drawings, is incorporated herein by reference in its entirety.

### REFERENCE SIGNS LIST

1 Application under test
2 Processed application
3 Terminal operation monitor program
4 Operation program
10 Management server
20 Operated terminal
30 Operating terminal
40 Operation display terminal
111 Control unit
112 Memory
113 Input unit
114 Output unit
115 Hard disk
116 CD-ROM drive
117 CD-ROM
118 Communication unit

What is claimed is:

1. An application test system for testing an application at a plurality of terminals, the application test system comprising:
a management server for managing an operation status of an operating terminal that is operated to test an application and an operation status of an operated terminal that is remotely operated in accordance with operation of the operating terminal,
wherein the management server includes
operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and
operation information transmission means for transmitting the operation information to the operated terminal in which the application under test and an operation program for operating the operated terminal based on the operation information are installed.

2. An application test system for testing an application at a plurality of terminals, the application test system comprising:
a management server for managing an operation status of an operating terminal that is operated to test an application and an operation status of an operated terminal that is remotely operated in accordance with operation of the operating terminal,
wherein the management server includes
application reception means for receiving an application under test,
processed application transmission means for transmitting a processed application obtained by injecting a terminal operation monitor program for monitoring the operation of the operating terminal into the application under test,
operation information reception means for receiving, from the operating terminal in which the processed application is installed, the operation information of the operating terminal that is monitored by the terminal operation monitor program, and
operation information transmission means for transmitting the operation information to the operated terminal in which the application under test and an operation program for operating the operated terminal based on the operation information are installed.

3. An application test system for testing an application at a plurality of terminals, the application test system comprising:
an operated terminal to be remotely operated in accordance with operation of an operating terminal that is operated to test an application; and
a management server for managing operation statuses of the operating terminal and the operated terminal,
wherein the management server includes
operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and
operation information transmission means for transmitting the operation information to the operated terminal in which the application under test and an operation program for operating the operated terminal based on the operation information are installed, and
wherein the operated terminal includes
operation information reception means for receiving the operation information from the management server, and
operation program control means for executing the operation program based on the operation information.

4. An application test system for testing an application at a plurality of terminals, the application test system comprising:
an operating terminal that is to be operated to test an application;
an operated terminal that is to be remotely operated in accordance with operation of the operating terminal; and
a management server for managing operation statuses of the operating terminal and the operated terminal,
wherein the management server includes
operation information reception means for receiving, from the operating terminal in which a processed application obtained by injecting a terminal operation monitor program for monitoring the operation of the operating terminal into an application under test is installed, operation information of the operating terminal that is monitored by the terminal operation monitor program, and
operation information transmission means for transmitting the operation information to the operated terminal in which the application under test and an operation program for operating the operated terminal based on the operation information are installed,
wherein the operating terminal includes
operation information generation means for generating, when being operated, the operation information based on the terminal operation monitor program, and
operation information transmission means for transmitting the operation information to the management server, and
wherein the operated terminal includes
operation information reception means for receiving the operation information from the management server, and
operation program control means for executing the operation program based on the operation information.

5. An application test system for testing an application at a plurality of terminals, the application test system comprising:
a management server for managing an operation status of an operating terminal that is operated to test an application and an operation status of an operated terminal that is remotely operated in accordance with operation of the operating terminal,
wherein the management server includes
operation information reception means for receiving, from the operating terminal in which an application under test and a terminal operation monitor program for monitoring the operation of the operating terminal are installed, operation information of the operating terminal that is monitored by the terminal operation monitor program, and
operation information transmission means for transmitting the operation information to the operated terminal in which the application under test and an operation program for operating the operated terminal based on the operation information are installed.

6. The application test system according to claim 1,
wherein the management server further includes
video data reception means for receiving, from the operated terminal, video data regarding the operation status of the operated terminal, and
video data transmission means for transmitting the video data to an operation display terminal for displaying the operation status of the operated terminal.

7. The application test system according to claim 3,
wherein the operated terminal further includes
video data generation means for generating video data regarding the operation status of the operated terminal, and
video data transmission means for transmitting the video data to the management server, and
wherein the management server further includes
video data reception means for receiving the video data from the operated terminal, and
video data transmission means for transmitting the video data to an operation display terminal for displaying the operation status of the operated terminal.

8. The application test system according to claim 3, further comprising:
an operation display terminal for displaying the operation status of the operated terminal,
wherein the operated terminal further includes
video data generation means for generating video data regarding the operation status of the operated terminal, and
video data transmission means for transmitting the video data to the management server,
wherein the management server further includes
video data reception means for receiving the video data from the operated terminal, and
video data transmission means for transmitting the video data to the operation display terminal, and
wherein the operation display terminal includes
video data reception means for receiving the video data from the management server, and
video data display means for displaying the video data.

9. The application test system according to claim 6,
wherein the management server further includes video file generation means for generating a video file recording the video data.

10. The application test system according to claim 1,
wherein the management server further includes operation record file generation means for generating an operation record file recording the operation information.

11. An application test method for testing an application at a plurality of terminals, the method comprising the following steps performed by a management server for managing an operation status of an operating terminal that is operated to test an application and an operation status of an operated terminal that is remotely operated in accordance with operation of the operating terminal:
receiving, from the operating terminal in which a processed application obtained by injecting a terminal operation monitor program for monitoring the operation of the operating terminal into an application under test is installed, operation information of the operating terminal that is monitored by the terminal operation monitor program; and
transmitting the operation information to the operated terminal in which the application under test and an operation program for operating the operated terminal based on the operation information are installed.

12. A tangible non-transitory computer-readable storage medium having the application test program stored therein, wherein the application test program configures a computer to perform as the hardware processor of claim 1.
